(19) United States
(12) Patent Application Publication
(10) Pub. No.: US 2011/0132204 A1
(43) Pub. Date: Jun. 9, 2011

(54) GREASE STRAINER

(76) Inventor: JOY DONNELLAN, Hayward, WI (US)

(21) Appl. No.: 12/974,033

(22) Filed: Dec. 21, 2010

Related U.S. Application Data
(63) Continuation-in-part of application No. 11/879,340, filed on Jul. 17, 2007, now abandoned.
(60) Provisional application No. 60/831,537, filed on Jul. 17, 2006.

(51) Int. Cl. A47J 37/10

(52) U.S. Cl. 99/425

(57) ABSTRACT

A grease strainer that will allow grease to drain from food through the strainer and into a food cooking apparatus such as a skillet when cooking pre-selected food items as the food cooks or as the strainer is raised above the level of grease in the food cooking apparatus. The grease strainer having a substantially flat plate like member of a predetermined shape and thickness with a plurality of apertures formed through the strainer to allow grease to drain. A handle having a predetermined shape is attached at a first end thereof to an upper surface adjacent an outer edge of the substantially plate like member.

### CONTINUATION IN PART TO RELATED APPLICATION

This application is a continuation in part of U.S. Utility patent application Ser. No. 11/879,340, filed Jul. 17, 2007, which is related to and claims priority from U.S. Provisional Patent Application Ser. No. 60/831,537 filed Jul. 17, 2006.

### FIELD OF THE INVENTION

The present invention relates, in general, to cookware and, more particularly, this invention relates to a food cooking apparatus with a strainer component that is used during the cooking process to allow grease to pass through the strainer and settle in the pan below.

### BACKGROUND OF THE INVENTION

Prior to the conception and development of the present invention, frying pans and strainers, as are generally well known in the prior art, have been used for cooking and preparing food. Specifically of interest to the present invention are the following: Wang U.S. Pat. No. 5,826,494 discloses a cooking device including a container, a collecting pan, a strainer member and a cover and suggests that the device may be used for removing excess oil from food. Marriot U.S. Pat. No. 6,827,224 discloses a food strainer that fits multiple pot and pan sizes for the use of straining liquid from solid food. Sizer U.S. Pat. No. 7,021,202 discloses a disposable strainer for use in lining a pot, pan or kettle in which food is deep fried.

### SUMMARY OF THE INVENTION

The present invention provides, in a first aspect, a grease strainer for use when cooking pre-selected food items. The grease strainer having a substantially flat plate like member with a predetermined shape and thickness and being made from a predetermined material and also having a plurality of apertures through the plate like member for allowing grease to drain through after the grease strainer is raised above the level of grease in a skillet. The grease strainer also having a handle member of a predetermined shape and made from a predetermined material and being attached at a first end thereof to an upper surface adjacent the outer edge of the plate like member.

According to a second aspect, there is provided a food cooking apparatus which includes a pre-selected cooking container having each of a first predetermined shape and a predetermined depth, and being manufactured from a first predetermined material. A substantially flat plate like member is provided which has each of a second predetermined shape and a first predetermined thickness. The substantially flat plate like member is manufactured from a second predetermined material. A plurality of apertures are formed through the substantially flat plate like member for allowing grease to drain therethrough after the substantially flat plate like member is raised above a level of grease in the container. A first handle member having a second predetermined shape is attached at a first end thereof to an outer edge of the substantially plate like member. The first handle member is manufactured from a second predetermined material. There is a lid member having a third predetermined shape which has a rim portion engageable with a rim portion of the container. A second handle member having a fourth predetermined shape is engageable with the lid member for removing the lid from the container and a notch is formed along the rim portion of the lid member for receiving therein the first handle member.

### OBJECTS OF THE INVENTION

It is, therefore, one of the primary objects of the present invention to provide a grease strainer and food cooking apparatus for use in cooking food and straining grease from the food as the food is cooked.

Another object of the present invention is to provide for an easy way to remove excess grease from food in a safe manner as it is cooking and when it is finished cooking.

Still another object of the present invention is to provide an apparatus for allowing grease to drain from food as it cooks and for containing the grease until the user can dispose of the grease.

Yet another object of the present invention is to provide an easy way for cooked food to be removed from its grease byproducts in such a way as to allow the grease to remain in a container and cool so that it may be handled easily and safely by the user.

An additional object of the present invention is to provide for a grease strainer and food cooking apparatus that is inexpensive to manufacture.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the grease strainer and food cooking apparatus according to one embodiment of the invention.

FIG. 2 is a perspective view of a lid for the grease strainer and food cooking apparatus.

FIG. 3 is a perspective view of the grease strainer and food cooking apparatus without the lid.

FIG. 4 is a side elevation view of the grease strainer illustrated in FIG. 1 showing feet attached to the bottom of the grease strainer.

FIG. 5 is a perspective view of another embodiment of the invention using a wire mesh screen instead of a metal plate.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

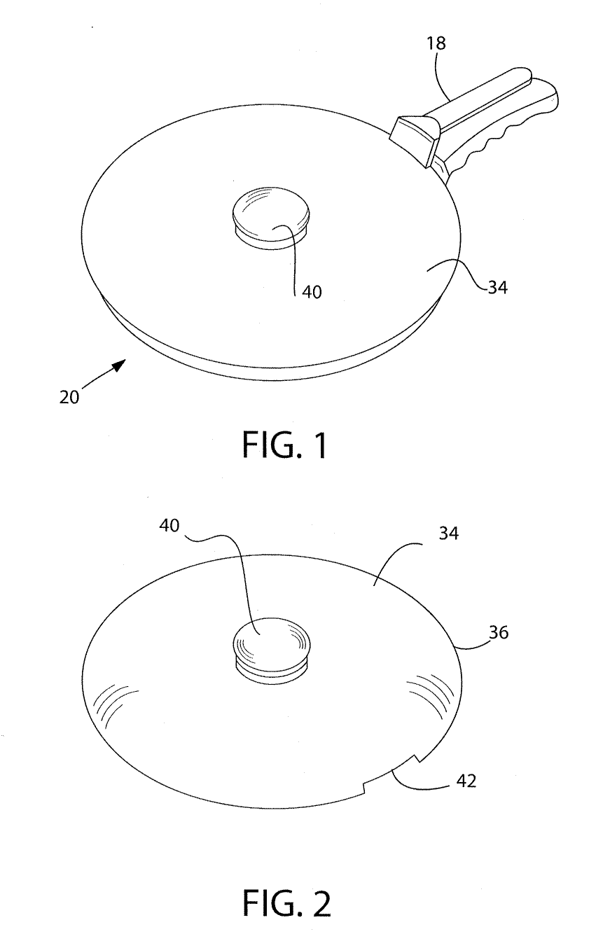

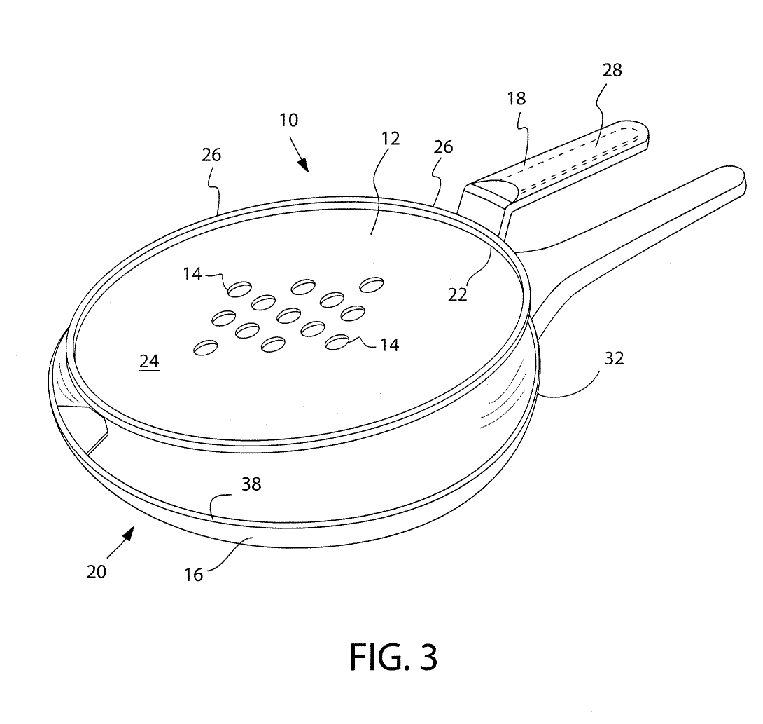

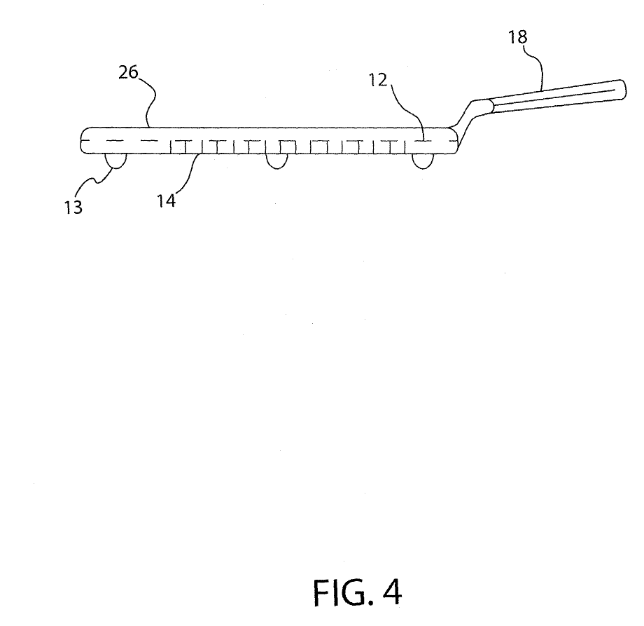

Reference is now made, more particularly, to FIGS. 1-4. According to a first embodiment of the invention illustrated in FIGS. 1-3, there is provided a grease strainer, generally designated 10, and a food cooking apparatus generally designated 20. The grease strainer 10 includes a substantially flat plate like member 12 having each of a first predetermined shape, which is preferably round, and a first predetermined thickness. The substantially flat plate like member is manufactured from a first predetermined material. Such first predetermined material is selected from the group consisting of metal and plastic. The metal selected from the group consisting of aluminum and steel. A plurality of apertures 14 are formed through the substantially flat plate like member 12 for allowing grease to drain therethrough after the substantially flat plate like member 12 is raised above a level of grease in a skillet 16, for example.

A handle member 18 having a second predetermined shape, preferably L-shaped, is attached at a first end 22 thereof to an upper surface 24 adjacent an outer edge 26 of the substantially plate like member 12. The handle member 18 is manufactured from a second predetermined material selected from the group consisting of metal and plastic. In the presently preferred embodiment of the invention, the grease strainer 10 further includes a heat resistant cover 28 disposed over a portion of the handle 18 which will be touched by a user of grease strainer 10. Further such handle member 18 may be removable from the substantially flat plate like member 12.

The grease strainer 10 further includes a lip portion 26 disposed on the upper surface 24 of the substantially flat plate like member 12 adjacent the outer edge 26 thereof.

The present invention further includes, in a second aspect as a portion of the food cooking apparatus 20, a pre-selected cooking container 32 having each of a first predetermined shape and a predetermined depth and which is manufactured from a first predetermined material.

There is a substantially flat plate like member 12 having each of a second predetermined shape and a first predetermined thickness, preferably between about one-eighth inch and about three sixteenth inch. Such substantially flat plate like member 12 is manufactured from a second predetermined material.

A plurality of apertures 14, preferably concave to allow better drainage of the grease from the grease strainer 10, are formed through the substantially flat plate like member 12 for allowing grease to drain therethrough after the substantially flat plate like member 12 is raised above a level of grease in the container 32.

A first handle member 18 having a second predetermined shape is attached at a first end 22 thereof to an outer edge 26 of the substantially flat plate like member 12. Such first handle member 18 is manufactured from a second predetermined material.

A lid member 34 having a third predetermined shape and a rim portion 36 engageable with a rim portion 38 of container 32 is provided.

There is a second handle member 40, having a fourth predetermined shape, preferably round, engageable with the lid member 34 for removing the lid member 34 from the container 32. A notch 42 formed along the rim portion 36 of the lid member 34 for receiving therein the first handle member 18. A length of the notch 42 is substantially equal to a width of the first handle member 18 adjacent such lid member 34 and the width of notch 42 is substantially equal to a thickness of first handle member 18 adjacent the lid member 34.

In this embodiment of the invention the first predetermined shape, second predetermined shape and third predetermined shape are substantially identical. Preferably, these shapes are generally round. Additionally, the third predetermined shape of the lid member 34 further includes a dome shaped portion.

In a presently preferred embodiment of the grease strainer 10 the substantially flat plat member 12 will include a plurality of feet members 13 attached to a bottom surface thereof. This arrangement allows one to cook foods with less grease or fat on the food thereby promoting healthier food preparation.

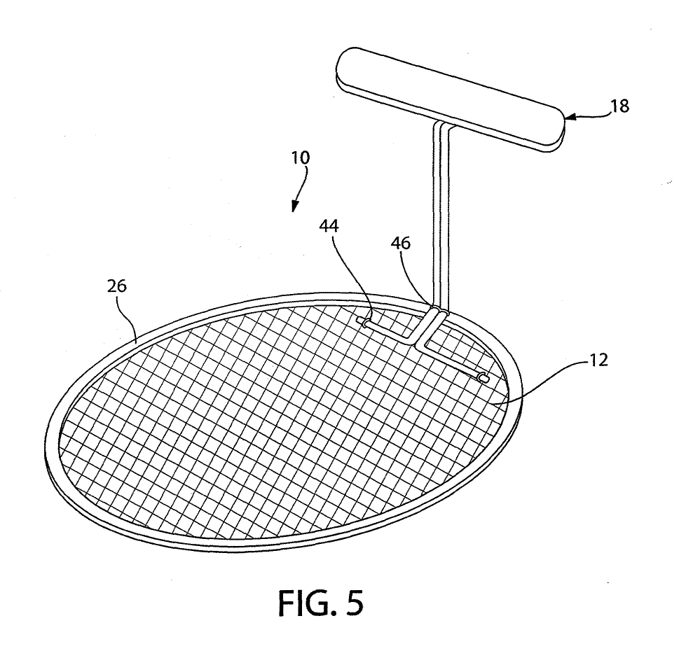

Reference is now made to FIG. 5, which shows a preferred embodiment of the invention. There is a substantially flat plate like member 12 having each of a second predetermined shape and a first predetermined thickness, preferably between about one-eighth inch and about one sixteenth inch. Such substantially flat plate like member 12 is manufactured from a wire mesh material. Such first handle member 18 is preferably attached to said substantially flat plate like member 12 by a hinge 44, thus allowing the handle member 18 to fold substantially flat with substantially flat plate like member 12. Preferably a handle securing means 46 is provided, specifically shown is a metal clip for securing the handle in a predetermined position.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A grease strainer for use in a skillet when cooking pre-selected food items, said grease strainer comprising:
(a) a substantially flat plate like member having each of a first predetermined shape and a first predetermined thickness, said substantially flat plate like member manufactured from a first predetermined material;
(b) a plurality of apertures formed through said substantially flat plate like member for allowing grease to drain therethrough after said substantially flat plate like member is raised above a level of grease in such skillet; and
(c) a handle member having a second predetermined shape attached at a first end thereof to an upper surface adjacent an outer edge of said substantially flat plate like member, said handle member manufactured from a second predetermined material.

2. A grease strainer, according to claim 1, wherein said grease strainer further includes a lip portion disposed on an upper surface of said substantially flat plate like member adjacent an outer edge thereof.

3. A grease strainer, according to claim 1, wherein said first predetermined shape of said substantially flat plate like member is generally round.

4. A grease strainer, according to claim 1, wherein said first predetermined material is wire mesh.

5. A grease strainer, according to claim 4, wherein said first predetermined material is metal wire mesh selected from the group consisting of aluminum and steel.

6. A grease strainer, according to claim 1, wherein said first predetermined material is plastic.

7. A grease strainer, according to claim 1, wherein said second predetermined material is selected from the group consisting of metal and plastic.

8. A grease strainer, according to claim 1, wherein said second predetermined shape of said handle member is generally L-shaped.

9. A food cooking apparatus for use in cooking foods submerged in grease, said food cooking apparatus, comprising:
(a) a pre-selected cooking container having each of a first predetermined shape and a predetermined depth, said pre-selected cooking container manufactured from a first predetermined material;
(b) a substantially flat plate like member having each of a second predetermined shape and a first predetermined thickness, said substantially flat plate like member manufactured from a second predetermined material;
(c) a plurality of apertures formed through said substantially flat plate like member for allowing grease to drain there through after said substantially flat plate like member is raised above a level of grease in said container;
(d) a first handle member having a second predetermined shape attached at a first end thereof to an outer edge of said substantially plate like member, said first handle member manufactured from a second predetermined material and further including a heat resistant cover over a portion of said first handle member which will be touched by a user;
(e) a lid member having a third predetermined shape, said lid member having a rim portion engageable with a rim portion of said container;
(f) a second handle member having a fourth predetermined shape engageable with said lid member for removing said lid from said container; and
(g) a notch formed along said rim portion of said lid member for receiving therein said first handle member.

10. A food cooking apparatus, according to claim 9, wherein said first predetermined shape, said second predetermined shape and third predetermined shape are substantially identical.

11. A food cooking apparatus, according to claim 9, wherein said first predetermined shape, said second predetermined shape and said third predetermined shape are generally round.

12. A food cooking apparatus, according to claim 11, wherein said third predetermined shape of said lid member further includes a dome shaped portion.

13. A food cooking apparatus, according to claim 9, wherein a length of said notch in said lid member is substantially equal to a width of said first handle member adjacent said lid member.

14. A food cooking apparatus, according to claim 13, wherein a width of said notch in said lid member is substantially equal to a thickness of said first handle member adjacent said lid member.

15. A food cooking apparatus, according to claim 9, wherein said food cooking container is a skillet.

16. A food cooking apparatus, according to claim 9, wherein said fourth predetermined shape of said second handle member is generally round.

17. A food cooking apparatus, according to claim 9, wherein said first predetermined thickness is between about one-eighth inch and about one sixteenth inch.

18. A food cooking apparatus, according to claim 9, wherein said first predetermined material is selected from metals and said second predetermined material is selected from metal and plastic.

19. A food cooking apparatus, according to claim 9, wherein said first predetermined material is selected from metals and said second predetermined material is selected from metal mesh and plastic mesh.

20. A grease strainer, according to claim 1, wherein said handle member is hingedly attached to said substantially flat plate like member.
